(19) United States
(12) Patent Application Publication
(10) Pub. No.: US 2026/0149474 A1
(43) Pub. Date: May 28, 2026

(54) DETECTING AND HANDLING ALIASED IMAGES OF NON-WLAN INTERFERENCE FOR STATIC PUNCTURING

(71) Applicant: Cisco Technology, Inc., San Jose, CA (US)

(72) Inventors: Matthew Aaron Silverman, Shaker Heights, OH (US); Ashish Pasha Sheikh, Akron, OH (US); Siddharth Sharma, Bangalore (IN); Michael J. Lyall, Novato, CA (US)

(21) Appl. No.: 18/958,021

(22) Filed: Nov. 25, 2024

(51) Int. Cl. H04B 1/04; H04B 17/309; H04L 1/00

(52) U.S. Cl. CPC H04B 1/0475; H04B 17/346; H04L 1/0013; H04B 2001/0416; H04B 2001/0491

(57) ABSTRACT

Techniques to detect when received energy in a portion of a radio frequency band is an aliased image of a source device (e.g., a non-WLAN interferer) and not an actual emission/transmission from a device. The aliased image may be caused by artifacts associated with the radio frequency downconverting and digital signal processing/sampling of a downconverted received signal. A determination is then made whether preamble puncturing should be used in a channel that is impacted by the aliased image to avoid that portion depending on whether the transmitting/receiving radio that sends/receives traffic would also be impacted by that aliased image.

### TECHNICAL FIELD

The present disclosure relates to wireless networking.

### BACKGROUND

Wireless local area networks, such as Wi-Fi® wireless local area networks (WLANs), operate in unlicensed bands where other non-Wi-Fi wireless devices may also operate. These non-Wi-Fi devices, such as microwave ovens, cordless phones, radio frequency (RF) jammers, motion detectors, and wireless security cameras, can be sources of interference that can disrupt operation of a Wi-Fi wireless network. Some wireless access points (APs) have interference detection capabilities to account for such interference and alter operational parameters of the wireless network, such as channel of operation, etc. Accurate detection of interference in a given channel of a frequency band can allow for more precise control of the wireless network.

### BRIEF DESCRIPTION OF THE DRAWINGS

FIG. 1 is a block diagram of a wireless local area network (WLAN) that may be configured to detect an aliased image of an actual non-WLAN interferer to determine whether or not to perform preamble puncturing, according to an example embodiment.

FIG. 2 is a block diagram of an access point in communication with a WLAN controller (WLC) each of which may be configured to perform techniques related to detecting and handling of an aliased image of a non-WLAN interferer, according to an example embodiment.

FIG. 3 is a high-level flow chart of a method for detecting and handling of an aliased image of a non-WLAN interferer, according to an example embodiment.

FIG. 4A is a diagram depicting operations for flagging a non-WLAN interferer as potentially being a source for an aliased image, according to an example embodiment.

FIG. 4B is a diagram depicting operations for determining whether detected interference is an aliased image of a detected non-WLAN interferer, according to an example embodiment.

FIG. 5 is a diagram depicting operations for determining whether preamble puncturing should be performed in a subchannel as a result of an aliased image impacting the subchannel of a plurality of subchannels used for serving WLAN traffic, according to an example embodiment.

FIG. 6 is a diagram depicting preamble puncturing of a subchannel as a result of determining that an aliased image impacts that subchannel, according to an example embodiment.

FIG. 7 is a hardware block diagram a device configured to perform functions associated with the aliased image detection and handling techniques presented herein.

### DETAILED DESCRIPTION

### Overview

Techniques are presented herein to detect when received energy in a portion of a radio frequency band is an aliased image of a source device (e.g., a non-WLAN interferer) and not an actual emission/transmission from a device. The aliased image may be caused by artifacts associated with the radio frequency downconverting and digital signal processing/sampling of a downconverted received signal. A determination is then made whether preamble puncturing should be used in a channel that is impacted by the aliased image to avoid that portion depending on whether the transmitting/receiving radio that sends/receives traffic would also be impacted by that aliased image.

Accordingly, a method is provided that includes receiving wireless signals in a frequency band that is shared by wireless local area network (WLAN) activity and non-WLAN activity that has potential to interfere with the WLAN activity. The method includes analyzing receive signal data to detect non-WLAN interference within the frequency band and determining whether the non-WLAN interference is an aliased image of activity at another portion of the frequency band. The method further includes determining whether to perform preamble puncturing in a WLAN channel in the frequency band based on whether the non-WLAN interference is an aliased image.

### Example Embodiments

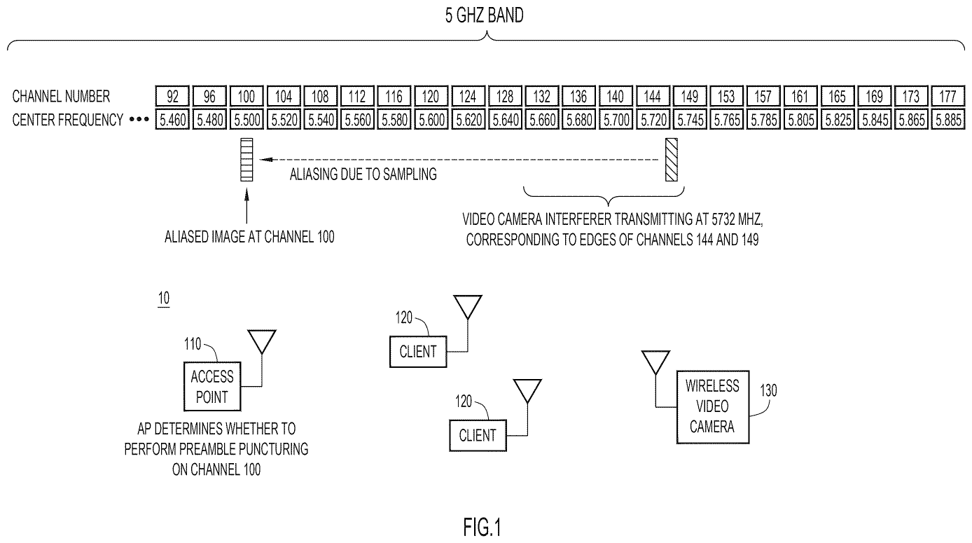

Reference is first made to FIG. 1. In real-world Wi-Fi wireless local area network (WLAN) deployments, it has been determined that interferer aliased “images” of a detected interferer occur every an integer number of some channel bandwidth from a center frequency of the interferer. FIG. 1 shows a simplified block diagram of a wireless network 10 that includes an access point (AP) 110 and a plurality of wireless clients (stations) 120. The AP 110 is operating in the 5 GHz unlicensed band (in the U.S.) as an example. FIG. 1 also shows a wireless video camera 130 that is also operating in sufficient physical radio frequency (RF) proximity to the AP 110 and clients 120. For example, the wireless video camera 130 is operating on the edge of channel 144 and channel 149. Due to aliasing and harmonics caused by the radio receiver and sampling by the analog-to-digital converter in the AP 110, an aliased image of the signal from the wireless video camera 130 (near channels 144 and 149) will also be detected on channel 100 by that same radio receiver of the AP 110. The interferer device (wireless video camera 130) is not actually transmitting signals at channel 100. A radio receiver and analog-to-digital converter will output receive signal data at channel 100, albeit likely at a lower signal strength (e.g., Receive Signal Strength Information, RSSI) than the signal strength of the signals at the edges of channels 144 and 149 from the wireless video camera 130. This aliased imaging occurs every integer multiple of the sampling rate of the radio receiver. In one example, if the sampling rate of the radio receiver (in an integrated circuit, for example) is 3-times (3×), the aliased images for an 80 MHz receiver bandwidth will be every 240 MHz.

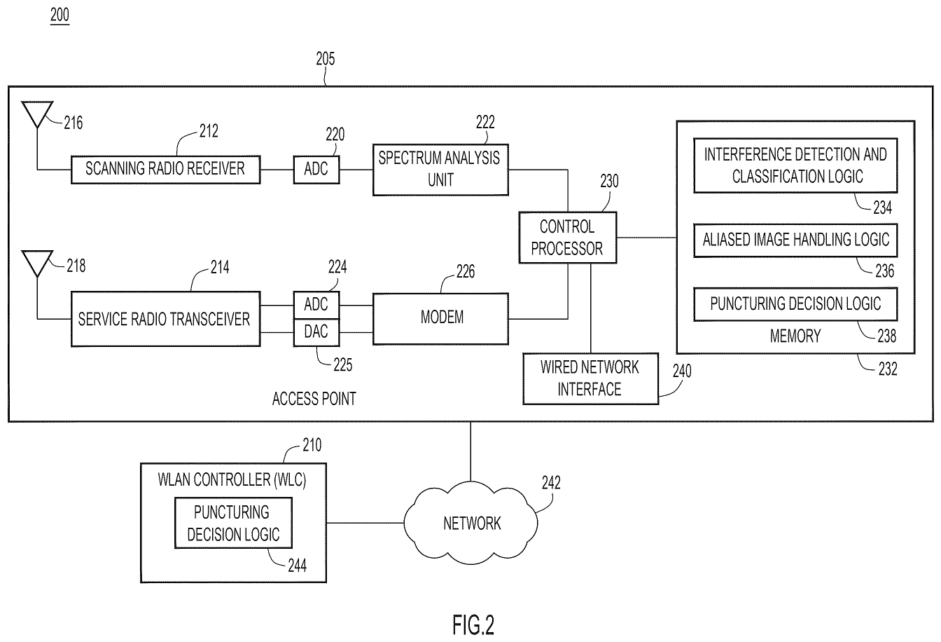

Reference is now made to FIG. 2. FIG. 2 illustrates a block diagram of a system 200 that includes an AP 205 that has network connectivity to a WLAN controller (WLC) 210. The AP 205 and WLC 210 shown in FIG. 2 may be configured to perform operations related to the embodiments presented herein. The AP 205 may take on a variety of forms, but in one example, the AP 205 includes a scanning radio receiver 212 and a service radio transceiver 214. The scanning radio receiver 212 has an associated antenna 216 and is configured to scan across a frequency band (e.g., 5 GHz unlicensed frequency band, 6 GHz unlicensed frequency band, 2.4 GHz unlicensed frequency band, etc.) to detect radio frequency (RF) activity at various channels of the frequency band. The service radio transceiver 214 has an associated antenna 218 (or a plurality of antennas) and is configured to perform RF reception and transmission with wireless clients that the AP 205 serves. Thus, the service radio transceiver 214 receives uplink transmissions carrying traffic from wireless clients and sends downlink transmissions carrying traffic to wireless clients. By contrast, the scanning radio receiver 212 receives energy in the frequency band but does not serve traffic to/from wireless clients.

The scanning radio receiver 212 is connected to an analog-to-digital converter (ADC) 220, and the ADC 220 is connected to a spectrum analysis unit 222. Though not shown in FIG. 2, the scanning radio receiver 212 includes an analog filter that has a baseband filtering response, and that baseband filtering response is used in assessing whether detected non-WLAN interference may be an aliased image of a non-WLAN interferer detected elsewhere in a frequency band of operation of the access point. The service radio transceiver 214 is connected to an ADC 224 and the ADC 224 is connected to a modem 226. Similarly, the service radio transceiver 214 is connected to a digital-to-analog converter (DAC) 225 to receive digital data from the modem for conversion to analog signals for the service radio transceiver 214 to transmit. It is to be understood that the ADC 220 may be included in the integrated circuit of the scanning radio receiver 212, and likewise, the ADC 224 and DAC 225 may be included in the integrated circuit(s) of the service radio transceiver 214. The spectrum analysis unit 222 and the modem 226 are coupled to a control processor 230. The modem 226 may also be referred to as a baseband processor and performs baseband modulation of downlink data to be provided, via DAC 225, to the service radio transceiver 214 for downlink transmission to a wireless client. The service radio transceiver 214 receives an uplink transmission from a wireless client and downconverts the received uplink transmission which the ADC 224 converts to baseband modulated receive signal data. The modem 226 performs baseband demodulation of the baseband modulated receive signal data and recovers the data included in the uplink transmission.

The control processor 230 may be a microcontroller or microprocessor, and is configured to executed instructions stored in a memory 232 to perform various control functions for the AP 205, such as channel tuning of the scanning radio receiver 212, channel adjustment of service radio transceiver 214, etc. To this end, the memory 232 stores executable instructions (e.g., software instructions or firmware) for interference detection and classification logic 234, aliased image handling logic 236 and puncturing decision logic 238.

The AP 205 further includes a wired network interface 240 (e.g., one or more network interface cards) that enables wired network connectivity, via network 242, to the WLC 210. The WLC 210 may also including puncturing decision logic 244 that enables the WLC 210 to make puncturing decisions, similar to that of puncturing decision logic 238, as described further below. The WLC 210 may be in the same building as the AP 205 or at an entirely remote location, e.g., in a data center.

In operation, the scanning radio receiver 212 tunes to different channels to make measurements on what it receives in order to determine how “clean” any given channel is, that is, how free it is from activity (either WLAN activity or non-WLAN activity/interference), on behalf of the service radio transceiver 214. The spectrum analysis unit 222 may be embodied in one or more application specific integrated circuits and is configured to perform high-resolution Fast Fourier Transform (FFT) operations and pulse detection operations, for detection of bursts of RF energy in frequency in time. In some cases, the spectrum analysis unit 222 may combine pulses that match each other, to be considered as a single pulse. The spectrum analysis unit 222 passes samples of pulses determined to be of interest, to the control processor 230 for more detailed fingerprint analysis. In some cases, a separate processor may be employed to analyze the output of the spectrum analysis unit 222, but for simplicity a signal control processor 230 is shown in FIG. 2 that performs these functions.

For example, the control processor 230 may execute the interference detection and classification logic 234 to analyze timing and frequency characteristics of interference bursts, as well as attributes of the bursts, including modulation type and any identified sync words. This enables distinguishing one interferer device/source from another. The interference detection and classification logic 234 may distinguish several different interferers—either of the same type or different types—that are operating at the same time. This can be useful because in the real world, the amount of simultaneous RF activity can be quite high. One use of interference detection is to change channels for serving traffic for wireless clients if the interference source is strong enough to disrupt service on a given channel. The control processor 230 may remember by storing information for detected intermittent interference from a microwave oven, bridge or a wireless video camera, in order to avoid the channels where these devices operate to prevent interference in the future.

As explained above in connection with FIG. 1, when the ADC 220 of the AP 205 samples downconverted received signals from the scanning radio receiver 212, there could be energy on an integer multiple of a channel where the activity is actually occurring, as a result of the operations of the scanning radio receiver 212 and the sampling process performed by the ADC 220. In the 6 GHz band, this can be happening quite often. Again, for an 80 MHz bandwidth and 3× oversampling, an aliased image could be observed every 240 MHz. This can appear, based on the output of the sampling by the ADC 220 of the downconverted energy, that the interferer exists every 240 MHz (but at weaker levels though strong enough to be detected), even though it is not actually occurring over-the-air at those other frequencies. Thus, the scanning radio receiver 212 may output receive signal data for interferers on channels where they do not really exist, but are artifacts of the radio frequency receiving (downconverting) and sampling process. The detection may be an interferer to output of the scanning radio receiver 212 but the service radio transceiver 214 may not detect what the scanning radio receiver 212 outputs as an aliased image.

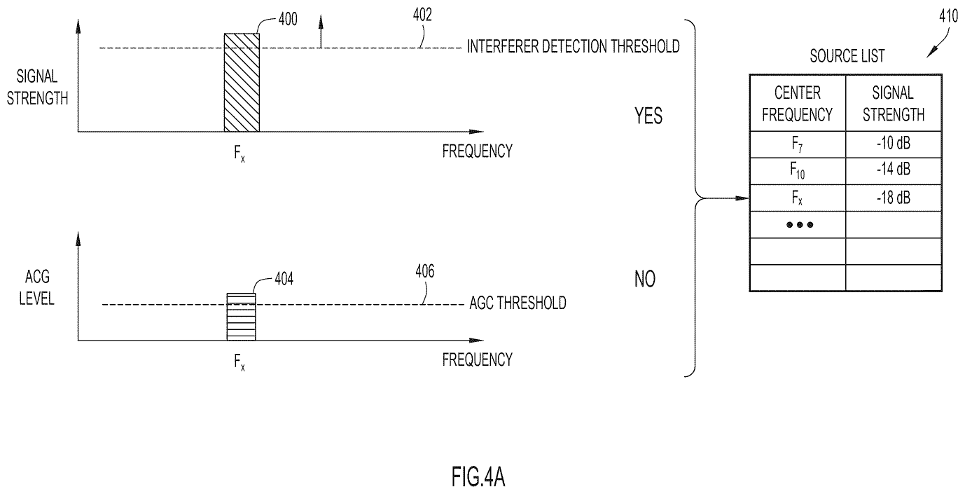

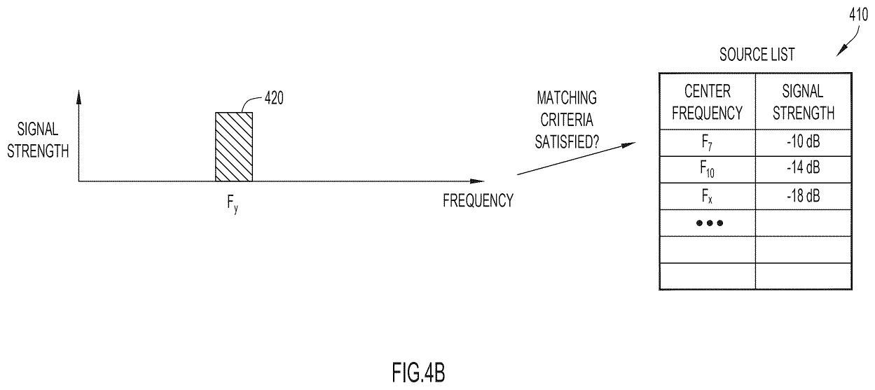

The aliased image handling logic 236 is provided to distinguish between an aliased image and a real/actual interferer, as described further below. This can be useful in the decision of whether or not to do preamble puncturing on a channel, which is the purpose of the puncturing decision logic 238. As described in more detail below in connection with FIGS. 4A and 4B, the aliased image handling logic 236 involves determining whether a non-WLAN interference is an aliased image by determining whether a center frequency of the non-WLAN interference matches an entry in a source list of previously detected non-WLAN interferers.

The puncturing decision logic 238 obtains as input the output of the aliased image handling logic 236 to determine whether or not to perform preamble puncturing on a channel, as described further below. If the service radio transceiver 214 is operating on a channel where the scanning radio receiver 212 observes a non-WLAN interferer, it is possible that the service radio transceiver 214 does not observe the same aliased image as observed by the scanning radio receiver 212. Thus, preamble puncturing on that channel would be inappropriate. Said another way, there would be no need to go to the effort to puncture on a channel when there is not actually an non-WLAN interferer occupying part (or all) of that channel. On the other hand, preamble puncturing would be appropriate to do if there is a real interferer impacting the channel, or if it is an aliased image that the service radio transceiver 214 would observe. In sum, there is a benefit in determining when a possible aliasing event occurs in detecting an interferer, and to determine if that aliasing event would also impact the service radio and, therefore, puncturing should be done.

While the techniques presented herein are described with respect to an AP having a dual radio architecture, this is not meant to be limiting. An AP with a single radio transceiver that can perform scanning of channels to gather information about activity on a channel as well as serve wireless traffic may perform these techniques.

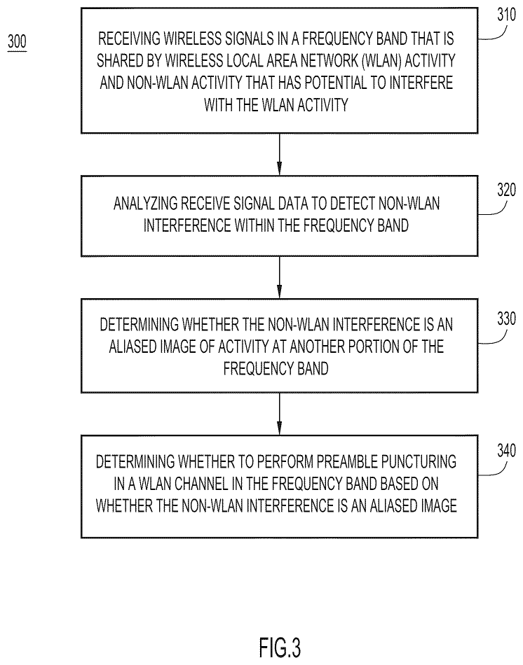

Turning now to FIG. 3, a flow chart is shown depicting, at a high-level, a method 300 performed according to the embodiments presented herein. Reference is also made to FIG. 2 for purposes of the description of FIG. 3. At step 310, the method 300 involves receiving wireless signals in a frequency band that is shared by WLAN activity as well as non-WLAN activity that has the potential to interfere with the WLAN activity. This step is performed, for example, by the scanning radio receiver 212 of the AP 205 shown in FIG. 2.

At step 320, the method 300 involves analyzing receive signal data to detect non-WLAN interference within the frequency band. This step is performed, for example, by the spectrum analysis unit 222 and the control processor 230 executing the instructions for the interference detection and classification logic 234 stored in memory 232.

At step 330, the method 300 involves determining whether the non-WLAN interference is an aliased image of activity at another portion of the frequency band. This step is performed, for example, by the control processor 230 executing instructions for the aliased image handling logic 236 stored in memory 232.

At step 340, the method 300 involves determining whether to perform preamble puncturing in a WLAN channel in the frequency band based on whether the non-WLAN interference is an aliased image. Step 340 is performed, for example, by the control processor 230 executing instructions for the puncturing decision logic 238 stored in memory 232 or by the WLC 210 executing instructions for the puncturing decision logic 244. Thus, in one form, the AP 205 makes the decision whether or not to puncture a given channel, and in another form, the AP 205 pushes the output of the aliased image handling logic 236 and the interference detection and classification logic 234 to the WLC 210 and the puncturing decision logic 244 of the WLC makes the decision whether or not the AP 205 should puncture a given channel. If a channel is actually impacted by another over-the-air signal, then IEEE 802.11 specification rules allow for puncturing that subchannel (e.g., 20 MHz subchannel) to use at least a portion of that subchannel in the presence of non-WLAN interference. Consequently, an aliased image can lead to incorrectly identifying a subchannel that should be punctured because the scanning radio detected non-WLAN interference, but actually it was just an aliased image of a signal elsewhere in the frequency band (not actually impacting a given channel or subchannel). On the other hand, it may be determined that the service radio transceiver is likely to be impacted by that aliased image, and it may be desirable to perform preamble puncturing even though there is not an actual over-the-air signal present at that portion of the frequency band.

Turning now to FIG. 4A, with continued reference to FIG. 1, further details are now provided for step 330 that involves determining whether the non-WLAN interference is an aliased image of activity at another portion of the frequency band. Typically, detection of an aliased image of interferer will happen if the interferer is strong enough as observed by the radio that is trying to detect it. This may result from the receive signal strength (e.g., received signal strength information (RSSI) of the interferer being very high or detection of it is missed altogether because it is higher than the detection threshold of the radio receiver. Thus, step 330 involves determining when the energy observed (of a detected non-WLAN interferer) is an aliased image and not an actual over-the-air interferer. Again, if it is an aliased image, preamble puncturing may not be appropriate.

To determine whether a detected non-WLAN interferer is an aliased image of an actual/real interferer on another channel, the following may be performed. The interference detection and classification logic 234 of the AP 205 will flag non-WLAN interferer detections on a particular channel if the received signal strength of the non-WLAN interferer is greater than a threshold (e.g., −30 dBm) that would be high enough to produce a detectable aliased image on some other channel given the known analog filtering suppression of the baseband filter of the radio receiver, e.g., of the scanning radio receiver 212. For example, if the threshold is exceeded then it is possible that there may be an aliased image at (plus or minus) integer multiples (up to a certain separation in frequency) from the frequency where that non-WLAN interference detection was made. This is illustrated in FIG. 4A, where at a frequency Fₓ, a non-WLAN interferer 400 is detected that exceeds an interferer detection threshold 402, and thus a flag is set for a non-WLAN interferer at frequency Fₓ as indicated by the “YES” in FIG. 4A.

In a scenario where there is no detection due to the receive signal strength of the interferer being too high, a flag is also set at that frequency if an unusually low automatic gain control (AGC) level is encountered. In other words, if the AGC level 404 at a given frequency was set to be lower than an AGC threshold 406 (even zero), this is flagged because an AGC level being very low may indicate that a very strong signal was detected and the AGC level needed to be turned down (or off entirely) in order to receive it. In the example of FIG. 4A, the AGC level 404 is greater than the AGC threshold 406 so a flag is not set for this, as indicated by the “NO” in FIG. 4A.

A flagged non-WLAN interferer or flagged low AGC level event is added to a list of possible sources of an aliased image. This list is called a “Source List”. An example of a Source List is shown at 410 in FIG. 4A. In the example of FIG. 4A, the signal strength of the detected non-WLAN interferer 400 exceeds interferer detection threshold 402 but the AGC level at frequency Fₓ exceeds the AGC threshold. Thus, frequency Fₓ is flagged in the Source List 410 due to the signal strength of the non-WLAN interferer 400 (not due to the AGC level 404). The signal strength at frequency Fₓ is also indicated in the Source List 410, e.g., −18 dB. FIG. 4A shows that data for other non-WLAN interferer detections (or low AGC levels) are already in the Source List 410. Thus, each entry in the Source List 410 includes a center frequency for a corresponding previously detected non-WLAN interferer, but more specifically, an entry is populated in the Source List 410 for: (a) a detected non-WLAN interferer having a receive signal strength greater than a threshold; or (b) an automatic gain control (AGC) setting lower than a predetermined level. The threshold for the receive signal strength is a level determined to be sufficiently high so as to produce an aliased image on another channel based on characteristics of a receiver device (e.g., the scanning radio receiver 212).

The Source List 410 is used for matching new/subsequent non-WLAN interferer detections. To this end, reference is now made to FIG. 4B. When scanning other channels, if a new/subsequent non-WLAN interferer detection occurs, the detection frequency of that new/subsequent non-WLAN interferer is compared against the Source List. If the center frequency and the receive signal strength of the new non-WLAN interferer detection is a match for aliasing on any of the entries/members of the Source List, it is flagged as an “aliased image” detection.

More specifically, the “criteria for matching an aliasing source” may be:
(i) The center frequency of the detected interferer is an integer multiple (N×Bw_scan(k)) Hz away from the center frequency of an interferer on the Source List, where N is an integer corresponding to known oversampling of the scanning radio receiver and Bw_scan(k) is the bandwidth of the scanning radio receiver when on channel k where the detection occurred; and
(ii) The receive signal strength of the detected interferer is Z dB lower than that of the source (entry) in the Source List. Z is based on the frequency separation and a known baseband filtering response of the analog filter of the scanning radio receiver.

Thus, for the non-WLAN interferer 420 detected at frequency F_{y}, a determination is made whether F_{y} is N×Bw_scan(k) Hz away from the center frequency of an interferer on the Source List 410, and the receive signal strength is Z dB lower than that of the matching source in the Source List 410 (if there is match). If, for example, the center frequency is F_{y} is N×Bw_scan(k) Hz away from the center frequency Fₓ in the Source List 410 and the signal strength of the non-WLAN interferer 420 is Z dB less than −18 dB (the signal strength of the source at frequency Fₓ), then the matching criteria is satisfied and the non-WLAN interferer 420 is said to be an aliased image of the source at center frequency Fₓ. Otherwise, if there is no match (according to the above matching criteria) to a source in the Source List 410, then the non-WLAN interferer 420 is not flagged as an aliased image.

When the detected non-WLAN interferer 420 is flagged as a possible aliased image and is paired with a source(s) in the Source List 410, it could be an image from the Source List. This may be communicated to the WLC 21—or to a host of the AP 205 along with the detection event for consumption by the puncturing decision logic 238 running on the AP 205 or the puncturing decision logic 244 running on the WLC 210. Alternatively, if an interferer is determined to be an aliased image, this may not be reported up to the puncturing decision logic (on the AP 205 or the WLC 210) since puncturing may be deemed unnecessary for an aliased image.

### Puncturing Decision on the AP or WLC

The puncturing decision logic 238 on the AP 205 (or the puncturing decision logic 244 on the WLC 210) receives as input, interference classification events including aliased images, if desired, as described above. The puncturing decision logic 238 (or puncturing decision logic 244) determines whether the service radio transceiver 214 would observe that same aliased image such it may impact performance of the service radio transceiver on a particular channel (even though the aliased image is not an actual over-the-air signal).

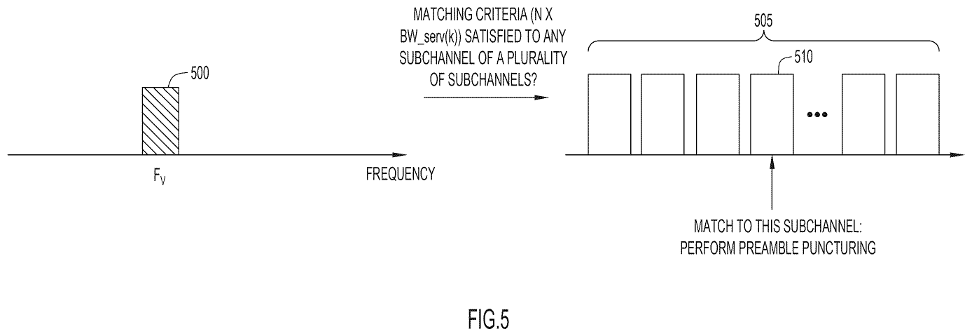

Reference is now made to FIG. 5. Similar criteria used in matching a detected interferer to a source in the Source List may be used for all (20 MHz) subchannels of the service radio transceiver to determine if that aliased image would be observed (show up) in any subchannel of a plurality of subchannels in which the service radio transceiver operates. If the aliased image matches to a subchannel, then preamble puncturing on that subchannel is performed. Thus, as shown in FIG. 5, the aliased image 500 (corresponding to the detected non-WLAN interferer 420 from FIG. 4B) is considered for whether it is N×Bw_serv(k) away from any subchannel of the plurality of subchannels in which the service radio transceiver operates, where N is an integer corresponding to known oversampling of the service radio transceiver and Bw_serv(k) is a bandwidth of the service radio transceiver when on a given subchannel k. If the center frequency (F_{y}) of the aliased image is an integer multiple (N×Bw_serv(k)) away from a center frequency of a subchannel of the plurality of subchannels, then a match is said to be made to that subchannel and preamble puncturing is performed in that subchannel. In the example of FIG. 5, the plurality of subchannels are shown at reference numeral 505, and it is determined that F_{y} is N×Bw_serv(k) away from subchannel 510. Thus, the service radio transceiver performs preamble puncturing in subchannel 510.

If the aliased image does not match to a subchannel of the plurality of subchannels based on the matching criteria, then the aliased image may be ignored.

In one form of applying the matching criteria for the service radio transceiver, the frequency and bandwidth of the service radio transceiver are checked to see if both criteria (i) and (ii) also apply to any subchannel of the current channel of the service radio transceiver. If both criteria are not met, then the detection event is discarded before the puncturing decision block ever receives it. If both criteria are met, then it may be appropriate to do puncturing at the channel where the aliased image occurs because it would impact the service radio performance.

In another embodiment, instead of determining that the detection is an aliased image at the time of detection, the interferer type and receive signal strength are provided to the puncturing decision logic. The puncturing decision logic evaluates patterns of detections across channels to determine if there are matches according to the criteria above.

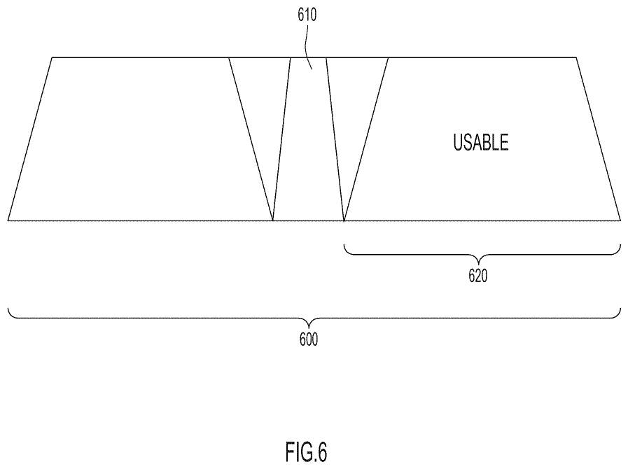

Reference is now made to FIG. 6 to illustrate an example of preamble puncturing performed in a subchannel where the aliased image is determined to match (based on the matching criteria described above in connection with FIG. 5). FIG. 6 shows a subchannel 600 in which an aliased image 610 is determined to match, that is, fall within, according to the matching criteria described above with respect to FIG. 5. But the aliased image 610 does not occupy the entire subchannel and there is a portion of the subchannel, referred to the as the usable portion 620, not occupied by the aliased image 610, that can be used for WLAN operation without being impacted by the aliased image 610. Thus, preamble puncturing is performed in the subchannel 600 to make use of the usable portion 620 of the subchannel 600.

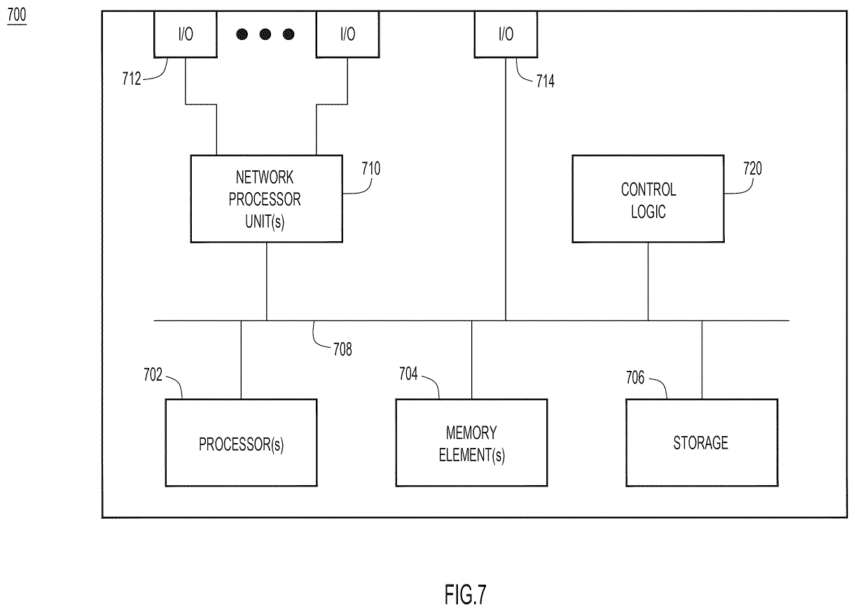

Referring to FIG. 7, FIG. 7 illustrates a hardware block diagram of a device that perform the operations of an AP or WLC in connection with the techniques described herein.

In at least one embodiment, the device 700 may include one or more processor(s) 702, one or more memory element(s) 704, storage 706, a bus 708, one or more network processor unit(s) 710, network input/output (I/O) interfaces 712 and an I/O interface 714. The device 700 may further include control logic 720. In various embodiments, instructions associated with logic for device 700 can overlap in any manner and are not limited to the specific allocation of instructions and/or operations described herein.

In at least one embodiment, processor(s) 702 is/are at least one hardware processor configured to execute various tasks, operations and/or functions for device 700 as described herein according to software and/or instructions configured for device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with device 700, and/or logic configured for memory element(s) 704 and/or storage 706. For example, any logic described herein (e.g., control logic 720) can, in various embodiments, be stored for device 700 using any combination of memory element(s) 704 and/or storage 706. Note that in some embodiments, storage 706 can be consolidated with memory element(s) 704 (or vice versa) or can overlap/exist in any other suitable manner.

In at least one embodiment, bus 708 can be configured as an interface that enables one or more elements of device 700 to communicate in order to exchange information and/or data. Bus 708 can be implemented with any architecture designed for passing control, data and/or information between processors, memory elements/storage, peripheral devices, and/or any other hardware and/or software components that may be configured for device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information (wired and/or wirelessly) in a network environment.

I/O interface(s) 714 allow for input and output of data and/or information with other entities that may be connected to device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include a method as shown and described herein. In one form an apparatus as shown and described herein is provided. In one form, a system as shown and described herein is provided. In one form, one or more computer readable storage media encoded with software comprising computer executable instructions is/are provided herein that, when the software, is/are executed operable to perform operations as shown and described herein.

In some aspects, the techniques described herein relate to a method including: receiving wireless signals in a frequency band that is shared by wireless local area network (WLAN) activity and non-WLAN activity that has potential to interfere with the WLAN activity; analyzing receive signal data to detect non-WLAN interference within the frequency band; determining whether the non-WLAN interference is an aliased image of activity at another portion of the frequency band; and determining whether to perform preamble puncturing in a WLAN channel in the frequency band based on whether the non-WLAN interference is an aliased image.

In some aspects, the techniques described herein relate to a method, wherein determining whether the non-WLAN interference is an aliased image includes determining whether a center frequency of the non-WLAN interference matches an entry in a source list of previously detected non-WLAN interferers.

In some aspects, the techniques described herein relate to a method, wherein each entry in the source list includes a center frequency for a corresponding previously detected non-WLAN interferer.

In some aspects, the techniques described herein relate to a method, wherein an entry is populated in the source list for: (a) a detected non-WLAN interferer having a receive signal strength greater than a threshold; or (b) an automatic gain control (AGC) setting lower than a predetermined level.

In some aspects, the techniques described herein relate to a method, wherein the threshold is a level determined to be sufficiently high so as to produce an aliased image on another channel based on characteristics of a receiver device used for performing the receiving.

In some aspects, the techniques described herein relate to a method, wherein criteria for determining whether a center frequency of the non-WLAN interference matches an entry in the source list includes: a center frequency of the non-WLAN interference is an integer multiple (N×Bw_scan(k)) away from a center frequency of an entry in the source list, where N is an oversampling of a radio receiver used for performing the receiving and Bw_scan(k) is a bandwidth of the radio receiver when on a given channel k; and a received signal strength of the non-WLAN interference is a predetermined amount lower than that of a matching entry in the source list, where the predetermined amount is based on a baseband filtering response of an analog filter used in the radio receiver.

In some aspects, the techniques described herein relate to a method, wherein determining whether the non-WLAN interference is an aliased image is performed based on the receive signal data that is obtained from a scanning radio receiver of an access point that also includes a service radio transceiver that serves client devices in the WLAN, and the determining whether to perform preamble puncturing is performed by a WLAN controller or by the access point.

In some aspects, the techniques described herein relate to a method, wherein determining whether to perform preamble puncturing is based on a determination that the aliased image would be detected by the service radio transceiver in a portion of the frequency band.

In some aspects, the techniques described herein relate to a method, wherein criteria for determining whether to perform preamble puncturing includes whether a center frequency of the aliased image is an integer multiple (N×Bw_serv(k)) away from a center frequency of a subchannel of a plurality of subchannels in which the service radio transceiver operates in the frequency band, where N is an oversampling of the service radio transceiver and Bw_serv(k) is a bandwidth of the service radio transceiver when on a given subchannel k.

In some aspects, the techniques described herein relate to a method, further including discarding an aliased image detection when it is determined that no subchannel of the plurality of subchannels of the service radio transceiver satisfies the criteria so that a preamble puncturing decision does not consider the aliased image.

In some aspects, the techniques described herein relate to a method, wherein determining whether to perform preamble puncturing is based on patterns of non-WLAN interference detections across channels in the frequency band.

In some aspects, the techniques described herein relate to an apparatus including: a radio receiver configured to receive wireless signals in a frequency band that is shared by wireless local area network (WLAN) activity and non-WLAN activity that has potential to interfere with the WLAN activity; and a processor device coupled to the radio receiver, wherein the processor device is configured to: analyze receive signal data derived from reception of the wireless signals in the frequency band to detect non-WLAN interference; determine whether the non-WLAN interference is an aliased image of activity at another portion of the frequency band; and determine whether to perform preamble puncturing in a WLAN channel in the frequency band based on whether the non-WLAN interference is an aliased image.

In some aspects, the techniques described herein relate to an apparatus, wherein the processor device is configured to determine whether non-WLAN interference is an aliased image by determining whether a center frequency of the non-WLAN interference matches an entry in a source list of previously detected non-WLAN interferers, and each entry in the source list includes a center frequency for a corresponding previously detected non-WLAN interferer.

In some aspects, the techniques described herein relate to an apparatus, wherein an entry is populated in the source list for: (a) a detected non-WLAN interferer having a receive signal strength greater than a threshold; or (b) an automatic gain control (AGC) setting lower than a predetermined level.

In some aspects, the techniques described herein relate to an apparatus, wherein the threshold is a level determined to be sufficiently high so as to produce an aliased image on another channel based on characteristics of the radio receiver.

In some aspects, the techniques described herein relate to an apparatus, wherein criteria for determining whether a center frequency of the non-WLAN interference matches an entry in the source list includes: a center frequency of the non-WLAN interference is an integer multiple (N×Bw_scan(k)) away from a center frequency of an entry in the source list, where N is an oversampling of a radio receiver used for performing the receiving and Bw_scan(k) is a bandwidth of the radio receiver when on a given channel k; and a received signal strength of the non-WLAN interference is a predetermined amount lower than that of a matching entry in the source list, where the predetermined amount is based on a baseband filtering response of an analog filter used in the radio receiver.

In some aspects, the techniques described herein relate to an apparatus, wherein the radio receiver is a scanning radio receiver than scans among channels in the frequency band, the apparatus further including: a service radio transceiver that serves client devices in the WLAN, the service radio transceiver being coupled to the processor device, wherein the processor device determines whether to perform preamble puncturing based on a determination that the aliased image would be detected by the service radio transceiver in a portion of the frequency band.

In some aspects, the techniques described herein relate to an apparatus, wherein criteria for determining whether to perform preamble puncturing includes whether a center frequency of the aliased image is an integer multiple (N×Bw_serv(k)) away from a center frequency of a subchannel of a plurality of subchannels in which the service radio transceiver operates in the frequency band, where N is an oversampling of the service radio transceiver and Bw_serv(k) is a bandwidth of the service radio transceiver when on a given subchannel k.

In some aspects, the techniques described herein relate to one or more non-transitory computer readable storage media encoded with instructions that, when executed by a processor, cause the processor to perform operations including: obtaining receive signal data associated with reception of wireless signals in a frequency band that is shared by wireless local area network (WLAN) activity and non-WLAN activity that has potential to interfere with the WLAN activity; analyzing the receive signal data to detect non-WLAN interference within the frequency band; determining whether the non-WLAN interference is an aliased image of activity at another portion of the frequency band; and determining whether to perform preamble puncturing in a WLAN channel in the frequency band based on whether the non-WLAN interference is an aliased image.

In some aspects, the techniques described herein relate to one or more non-transitory computer readable storage media, wherein determining whether the non-WLAN interference is an aliased image includes determining whether a center frequency of the non-WLAN interference matches an entry in a source list of previously detected non-WLAN interferers, each entry in the source list including a center frequency for a corresponding previously detected non-WLAN interferer.

In some aspects, the techniques described herein relate to one or more non-transitory computer readable storage media, wherein an entry is populated in the source list for: (a) a detected non-WLAN interferer having a receive signal strength greater than a threshold; or (b) an automatic gain control (AGC) setting lower than a predetermined level.

In some aspects, the techniques described herein relate to one or more non-transitory computer readable storage media, wherein the threshold is a level determined to be sufficiently high so as to produce an aliased image on another channel based on characteristics of a receiver device that receives the wireless signals in the frequency band.

In some aspects, the techniques described herein relate to one or more non-transitory computer readable storage media, wherein criteria for determining whether a center frequency of the non-WLAN interference matches an entry in the source list includes: a center frequency of the non-WLAN interference is an integer multiple (N×Bw_scan(k)) away from a center frequency of an entry in the source list, where N is an oversampling of a radio receiver used for performing the receiving and Bw_scan(k) is a bandwidth of the radio receiver when on a given channel k; and a received signal strength of the non-WLAN interference is a predetermined amount lower than that of a matching entry in the source list, where the predetermined amount is based on a baseband filtering response of an analog filter used in the radio receiver.

In some aspects, the techniques described herein relate to one or more non-transitory computer readable storage media, wherein determining whether the non-WLAN interference is an aliased image is performed based on the receive signal data that is obtained from a scanning radio receiver of an access point that also includes a service radio transceiver that serves client devices in the WLAN, and wherein determining whether to perform preamble puncturing is based on a determination that the aliased image would be detected by the service radio transceiver in a portion of the frequency band.

In some aspects, the techniques described herein relate to one or more non-transitory computer readable storage media, wherein criteria for determining whether to perform preamble puncturing includes whether a center frequency of the aliased image is an integer multiple (N×Bw_serv(k)) away from a center frequency of a subchannel of a plurality of subchannels in which the service radio transceiver operates in the frequency band, where N is an oversampling of the service radio transceiver and Bw_serv(k) is a bandwidth of the service radio transceiver when on a given subchannel k.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4(IPv 4 ) and/or IP version 6(IPv 6 ) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
receiving wireless signals in a frequency band that is shared by wireless local area network (WLAN) activity and non-WLAN activity that has potential to interfere with the WLAN activity;
analyzing receive signal data to detect non-WLAN interference within the frequency band;
determining whether the non-WLAN interference is an aliased image of activity at another portion of the frequency band; and
determining whether to perform preamble puncturing in a WLAN channel in the frequency band based on whether the non-WLAN interference is an aliased image.

2. The method of claim 1, wherein determining whether the non-WLAN interference is an aliased image includes determining whether a center frequency of the non-WLAN interference matches an entry in a source list of previously detected non-WLAN interferers.

3. The method of claim 2, wherein each entry in the source list includes a center frequency for a corresponding previously detected non-WLAN interferer.

4. The method of claim 2, wherein an entry is populated in the source list for:
(a) a detected non-WLAN interferer having a receive signal strength greater than a threshold; or
(b) an automatic gain control (AGC) setting lower than a predetermined level.

5. The method of claim 4, wherein the threshold is a level determined to be sufficiently high so as to produce an aliased image on another channel based on characteristics of a receiver device used for performing the receiving.

6. The method of claim 2, wherein criteria for determining whether a center frequency of the non-WLAN interference matches an entry in the source list includes:
a center frequency of the non-WLAN interference is an integer multiple (N×Bw_scan(k)) away from a center frequency of an entry in the source list, where N is an oversampling of a radio receiver used for performing the receiving and Bw_scan(k) is a bandwidth of the radio receiver when on a given channel k; and
a received signal strength of the non-WLAN interference is a predetermined amount lower than that of a matching entry in the source list, where the predetermined amount is based on a baseband filtering response of an analog filter used in the radio receiver.

7. The method of claim 1, wherein determining whether the non-WLAN interference is an aliased image is performed based on the receive signal data that is obtained from a scanning radio receiver of an access point that also includes a service radio transceiver that serves client devices in the WLAN, and the determining whether to perform preamble puncturing is performed by a WLAN controller or by the access point.

8. The method of claim 7, wherein determining whether to perform preamble puncturing is based on a determination that the aliased image would be detected by the service radio transceiver in a portion of the frequency band.

9. The method of claim 8, wherein criteria for determining whether to perform preamble puncturing includes whether a center frequency of the aliased image is an integer multiple (N×Bw_serv(k)) away from a center frequency of a subchannel of a plurality of subchannels in which the service radio transceiver operates in the frequency band, where N is an oversampling of the service radio transceiver and Bw_serv(k) is a bandwidth of the service radio transceiver when on a given subchannel k.

10. The method of claim 9, further comprising discarding an aliased image detection when it is determined that no subchannel of the plurality of subchannels of the service radio transceiver satisfies the criteria so that a preamble puncturing decision does not consider the aliased image.

11. The method of claim 8, wherein determining whether to perform preamble puncturing is based on patterns of non-WLAN interference detections across channels in the frequency band.

12. An apparatus comprising:
a radio receiver configured to receive wireless signals in a frequency band that is shared by wireless local area network (WLAN) activity and non-WLAN activity that has potential to interfere with the WLAN activity; and
a processor device coupled to the radio receiver, wherein the processor device is configured to:
analyze receive signal data derived from reception of the wireless signals in the frequency band to detect non-WLAN interference;
determine whether the non-WLAN interference is an aliased image of activity at another portion of the frequency band; and
determine whether to perform preamble puncturing in a WLAN channel in the frequency band based on whether the non-WLAN interference is an aliased image.

13. The apparatus of claim 12, wherein the processor device is configured to determine whether non-WLAN interference is an aliased image by determining whether a center frequency of the non-WLAN interference matches an entry in a source list of previously detected non-WLAN interferers, and each entry in the source list includes a center frequency for a corresponding previously detected non-WLAN interferer.

14. The apparatus of claim 13, wherein an entry is populated in the source list for:
(a) a detected non-WLAN interferer having a receive signal strength greater than a threshold; or
(b) an automatic gain control (AGC) setting lower than a predetermined level.

15. The apparatus of claim 14, wherein the threshold is a level determined to be sufficiently high so as to produce an aliased image on another channel based on characteristics of the radio receiver.

16. The apparatus of claim 13, wherein criteria for determining whether a center frequency of the non-WLAN interference matches an entry in the source list includes:
a center frequency of the non-WLAN interference is an integer multiple (N×Bw_scan(k)) away from a center frequency of an entry in the source list, where N is an oversampling of a radio receiver used for performing the receiving and Bw_scan(k) is a bandwidth of the radio receiver when on a given channel k; and
a received signal strength of the non-WLAN interference is a predetermined amount lower than that of a matching entry in the source list, where the predetermined amount is based on a baseband filtering response of an analog filter used in the radio receiver.

17. The apparatus of claim 12, wherein the radio receiver is a scanning radio receiver that scans among channels in the frequency band, the apparatus further comprising:
a service radio transceiver that serves client devices in the WLAN, the service radio transceiver being coupled to the processor device,
wherein the processor device determines whether to perform preamble puncturing based on a determination that the aliased image would be detected by the service radio transceiver in a portion of the frequency band.

18. The apparatus of claim 17, wherein criteria for determining whether to perform preamble puncturing includes whether a center frequency of the aliased image is an integer multiple (N×Bw_serv(k)) away from a center frequency of a subchannel of a plurality of subchannels in which the service radio transceiver operates in the frequency band, where N is an oversampling of the service radio transceiver and Bw_serv(k) is a bandwidth of the service radio transceiver when on a given subchannel k.

19. One or more non-transitory computer readable storage media encoded with instructions that, when executed by a processor, cause the processor to perform operations comprising:
obtaining receive signal data associated with reception of wireless signals in a frequency band that is shared by wireless local area network (WLAN) activity and non-WLAN activity that has potential to interfere with the WLAN activity;
analyzing the receive signal data to detect non-WLAN interference within the frequency band;
determining whether the non-WLAN interference is an aliased image of activity at another portion of the frequency band; and
determining whether to perform preamble puncturing in a WLAN channel in the frequency band based on whether the non-WLAN interference is an aliased image.

20. The one or more non-transitory computer readable storage media of claim 19, wherein determining whether the non-WLAN interference is an aliased image includes determining whether a center frequency of the non-WLAN interference matches an entry in a source list of previously detected non-WLAN interferers, each entry in the source list including a center frequency for a corresponding previously detected non-WLAN interferer.

21. The one or more non-transitory computer readable storage media of claim 20, wherein an entry is populated in the source list for:
(a) a detected non-WLAN interferer having a receive signal strength greater than a threshold; or
(b) an automatic gain control (AGC) setting lower than a predetermined level.

22. The one or more non-transitory computer readable storage media of claim 21, wherein the threshold is a level determined to be sufficiently high so as to produce an aliased image on another channel based on characteristics of a receiver device that receives the wireless signals in the frequency band.

23. The one or more non-transitory computer readable storage media of claim 20, wherein criteria for determining whether a center frequency of the non-WLAN interference matches an entry in the source list includes:
a center frequency of the non-WLAN interference is an integer multiple (N×Bw_scan(k)) away from a center frequency of an entry in the source list, where N is an oversampling of a radio receiver used for performing the receiving and Bw_scan(k) is a bandwidth of the radio receiver when on a given channel k; and
a received signal strength of the non-WLAN interference is a predetermined amount lower than that of a matching entry in the source list, where the predetermined amount is based on a baseband filtering response of an analog filter used in the radio receiver.

24. The one or more non-transitory computer readable storage media of claim 20, wherein determining whether the non-WLAN interference is an aliased image is performed based on the receive signal data that is obtained from a scanning radio receiver of an access point that also includes a service radio transceiver that serves client devices in the WLAN, and wherein determining whether to perform preamble puncturing is based on a determination that the aliased image would be detected by the service radio transceiver in a portion of the frequency band.

25. The one or more non-transitory computer readable storage media of claim 24, wherein criteria for determining whether to perform preamble puncturing includes whether a center frequency of the aliased image is an integer multiple (N×Bw_serv(k)) away from a center frequency of a subchannel of a plurality of subchannels in which the service radio transceiver operates in the frequency band, where N is an oversampling of the service radio transceiver and Bw_serv(k) is a bandwidth of the service radio transceiver when on a given subchannel k.
